(19) United States
(12) Patent Application Publication
(10) Pub. No.: US 2024/0310588 A1
(43) Pub. Date: Sep. 19, 2024

(54) OPTICAL BACKPLANE CONNECTOR SYSTEM

(71) Applicant: TE Connectivity Solutions GmbH, Schaffhausen (CH)

(72) Inventors: Mark Benton, Mundelein, IL (US); Keith Miller, MANHEIM, PA (US); Kyle Annis, HUMMELSTOWN, PA (US); William Weeks, IVYLAND, PA (US); Kevin Thackston, YORK, PA (US); Lynn Sipe, Mifflintown, PA (US); Robert Flaig, Lancaster, PA (US)

(21) Appl. No.: 18/605,120

(22) Filed: Mar. 14, 2024

Related U.S. Application Data
(60) Provisional application No. 63/452,385, filed on Mar. 15, 2023.
(60) Provisional application No. 63/538,205, filed on Sep. 13, 2023.

(51) Int. Cl. G02B 6/40; G02B 6/38

(52) U.S. Cl. CPC G02B 6/406; G02B 6/3897

(57) ABSTRACT

A backplane connector for mating with a daughter-card connector assembly, said backplane connector having a front and rear orientation and comprising: (a) a retainer block configured for attachment to a backplane and defining a plurality of ferrule slots, each slot configured to receive a ferrule; (b) a plurality of ferrules disposed in said ferrule slots; (c) a plurality of ferrule springs to urge said plurality of ferrules forwardly; and (d) Fwafera plurality of ferrule spring retainers for retaining said ferrule springs and being mounted rearward on said retainer block, wherein each ferrule spring retainer retains springs for two or more ferrules.

### REFERENCE TO RELATED APPLICATIONS

This application is based on U.S. Provisional Application No. 63/452,385, filed Mar. 15, 2023, and U.S. Provisional Application No. 63/538,205 filed, Sep. 13, 2023, both of which are incorporated by reference in their entirety.

### FIELD OF INVENTION

The present invention relates, generally, to a printed circuit board (PCB)-based, backplane connector assemblies, and, more specifically, to a PCB-based backplane connector system having a blind-mate optical interface.

### BACKGROUND

Printed circuit board (PCB)-based backplane connectors are well known. For example, the MULTIGIG RT interconnect family from TE Connectivity (TE) are employed in a variety of computer, communications, medical, industrial control, and military applications. These connector systems use a printed circuit board (PCB) card or “wafer” instead of a traditional pin and socket contact system, thereby eliminating the open pin field on the plug-in module portion of the backplane connectors and reducing the end user's exposure to field failure in card cage systems. A typical PCB backplane daughter card connector assembly comprises a housing defining a plurality of slots, in which each slot is configured to receive an individual PCB wafer.

Applicant recognized that the PCB wafer may be improved by adding functionality to the wafer to convert between electrical signals and optical signals. To that end, Applicant, discloses a high-density optical daughter-card connector assembly, described, for example, in U.S. Pat. No. 10,852,489. This optical daughter-card connector assembly fulfilled many needs, especially with respect to its configurable free-end optical fibers. Yet, Applicant recognizes an additional need for an optical daughter-card connector assembly that is blind mateable. The present invention fulfills these needs, among others.

### SUMMARY

The following presents a simplified summary of the invention to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Accordingly, in one embodiment, the present invention relates to a backplane connector for mating with a daughter-card connector assembly, the backplane connector having a front and rear orientation and comprising: (a) a retainer block configured for attachment to a backplane and defining a plurality of ferrule slots, each slot configured to receive a ferrule; (b) a plurality of ferrules disposed in the ferrule slots; (c) a plurality of ferrule springs to urge the plurality of ferrules forwardly; and (d) a plurality of ferrule spring retainers for retaining the ferrule springs and being mounted rearward on the retainer block, wherein each ferrule spring retainer retains springs for two or more ferrules.

### BRIEF DESCRIPTION OF DRAWINGS

FIG. 1 shows a perspective view of one embodiment of the daughter-card connector assembly of the present invention.

FIG. 2a shows a perspective view of the daughter-card connector assembly of FIG. 1 with fibers connecting the optical connector with the optical component, and FIG. 2b shows a close-up view of a portion of FIG. 2a.

FIG. 3 shows an exploded view of one embodiment of a backplane connector of the present invention.

FIGS. 4a and 4b show front and rear perspective views, respectively, of the backplane connector of FIG. 3.

FIG. 5 shows a front view of the backplane connector of FIG. 3.

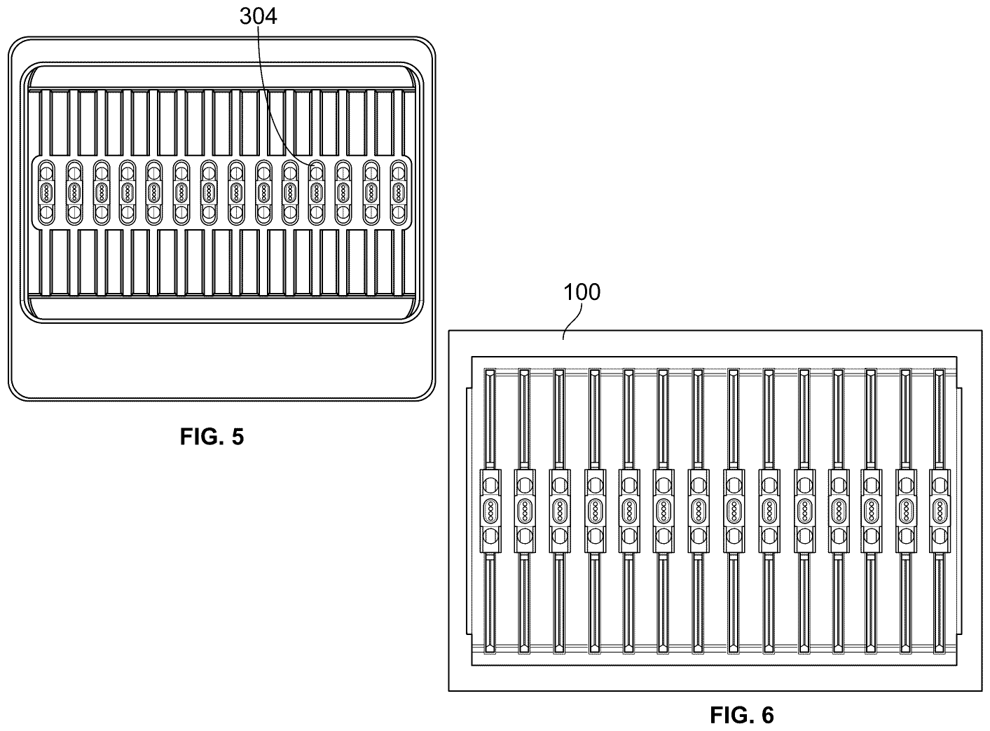

FIG. 6 shows a front view of the connector assembly of FIG. 1.

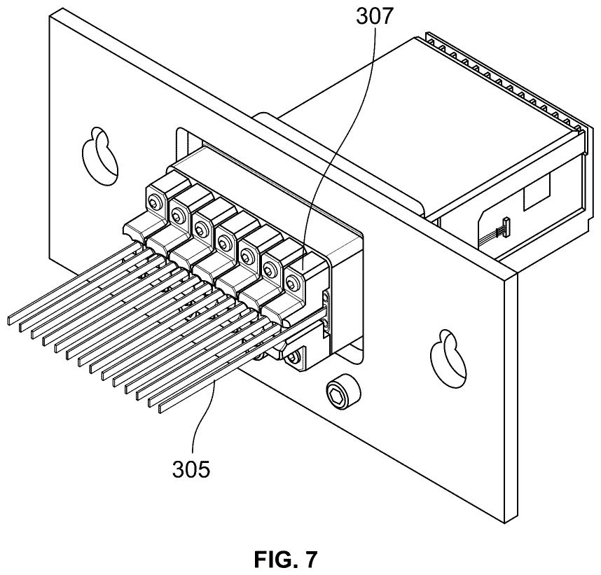

FIG. 7 shows a rear perspective view of the backplane connector of FIG. 3 coupled with the daughter-card connector assembly of FIG. 1.

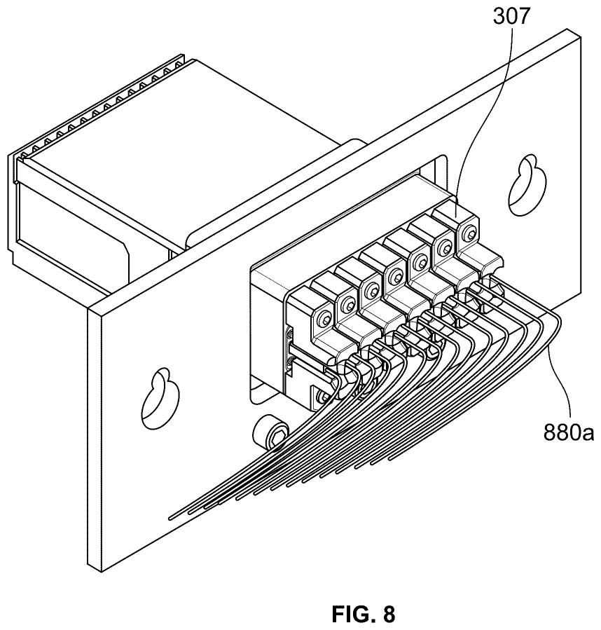

FIG. 8 shows a front perspective view of the backplane connector of FIG. 3 coupled with the daughter-card connector assembly of FIG. 1 with cables extending from the back of the backplane connector at an angle.

FIG. 9 shows a cross-sectional view of coupled connectors of FIG. 7.

FIGS. 10a-10d show perspective views of an alternative embodiment of a daughter-card connector assembly with heat sinks to draw heat away from the wafers.

### DETAILED DESCRIPTION

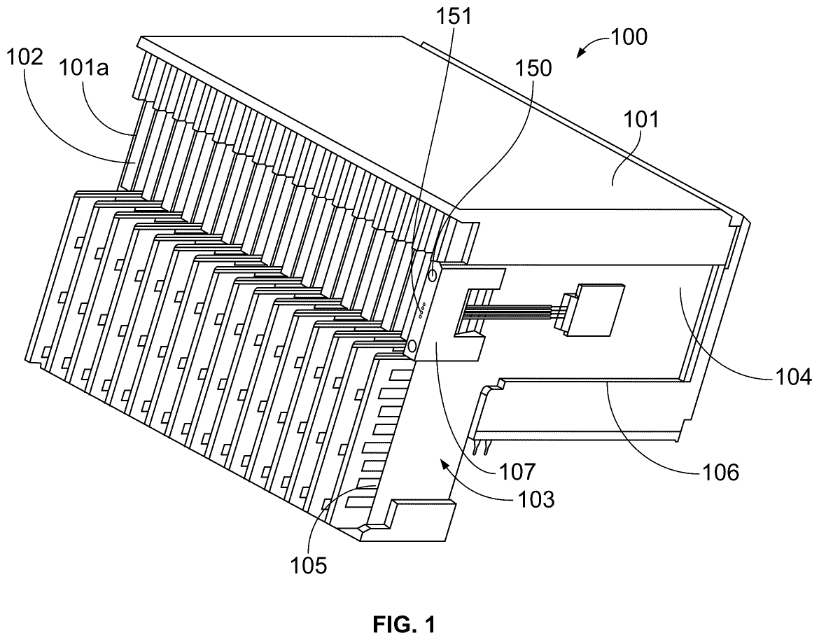

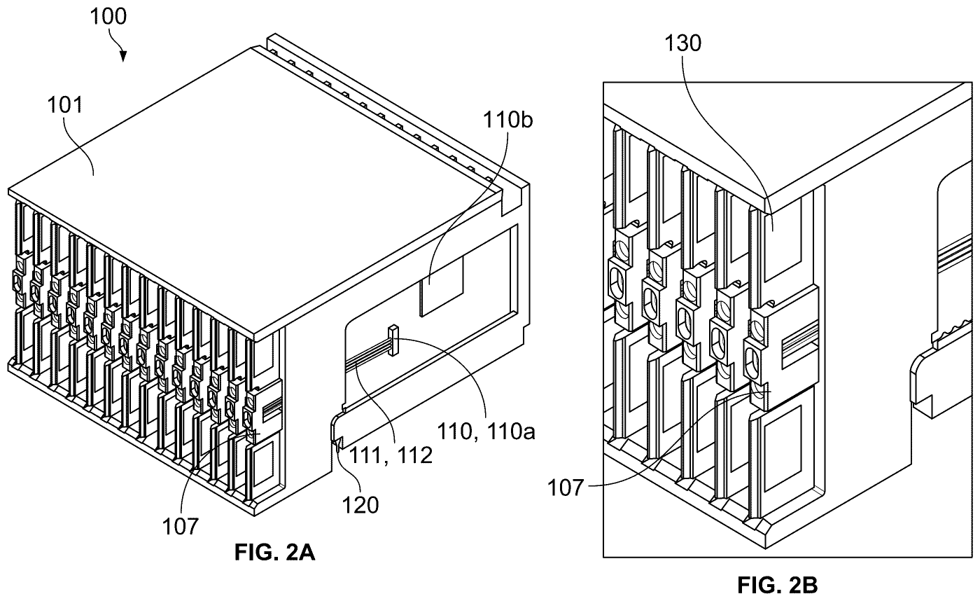

Referring to FIGS. 1-2, one embodiment of the daughter-card connector assembly 100 is shown. The daughter-card connector assembly 100 comprises a housing 101 defining a first plane 101a configured for mounting parallel to a backplane, and a second plane 101b for mounting parallel to a daughter card (not shown), and a plurality of parallel slots 102 perpendicular to the first plane. The daughter-card connector assembly 100 also comprises one or more opto-electric cards 103. Each of the one or more opto-electric cards disposed in one of the plurality of slots, and comprising at least, a printed circuit board (PCB) 104 having at least a first edge 105 and a second edge 106. When the opto-electric card is mounted in the slot, the first edge is parallel to the first plane and the second edge is parallel to the second plane. A blind-mate optical connector (or ferrule) 107 is disposed along the first edge, and an electrical interface is disposed along the second edge. (In the Figs., electrical interface is obscured by the housing 101.) At least one optical component 110 is mounted on the PCB for converting between electrical and optical signals, the PCB being electrically connected to at least a portion of the electrical interface. This particular embodiment, the optical component 110 comprises an opto-electric device 110a and drive circuitry 110b. One or more waveguides 111 connect the optical component with the optical connector. In this embodiment, the waveguides are optical fibers 112.

Each of these elements/features are described in detail below in connection with selected, alternative embodiments.

In one embodiment, the daughter-card connector assembly comprises discrete/modular opto-electric cards 104. In one embodiment, each discrete opto-electric card is releasably engageable with the housing 101. In one embodiment, the housing 101 comprises a plurality of slots 102 and each opto-electric card 104 is slidably engageable with one of the slots. Generally, each opto-electric card comprises one or more optical components for transmitting/receiving electrical/optical signals, although it should be understood that an opto-electric card may be a dedicated optical receiver, or a dedicated optical transmitter. In this respect, the modular configuration of the opto-electric card allows for a given daughter-card connector assembly to be configured in different ways. For example, a daughter-card connector assembly may comprise a portion of opto-electric cards configured for transceiving, and another portion of opto-electric cards dedicated to receiving and/or transmitting, depending on the application.

Not only does the modularity of the opto-electric card provide flexibility in configuring the daughter-card connector assembly with transceiving/transmitting/receiving opto-electric cards, but also provides scalability. That is, rather than purchasing and installing a daughter-card connector assembly with its full complement of channels, in one embodiment, the daughter-card connector assembly of the present invention may be scaled up to meet the demands of the application. For example, initially, a backplane connector housing with relatively few opto-electric cards may be installed, and, later, additional opto-electric cards may the added to the housing as the demand for additional channels grows. Thus, in one embodiment, the daughter-card connector assembly of the present invention provides for a pay-as-you-grow solution.

Another benefit of the modular configuration of the opto-electric card is the ability to replace defective opto-electric cards or to upgrade opto-electric cards periodically without having to replace the entire daughter-card connector assembly. In other words, unlike a conventional transceiver in which the entire transceiver must be replaced if one or more channels become inoperable, just the inoperable or out-of-date opto-electric card needs to be replaced in one embodiment of the backplane connector assembly. Thus, the modular configuration of the opto-electric cards eliminates single-point failures of the entire daughter-card connector assembly. Moreover, the discrete opto-electric card solution of the present invention enables a configurable ratio of channel protection. More specifically, the scalable configuration of the present invention enables the user to configure precisely the level of channel protection desired—e.g., from 1:1 redundancy to 1:N redundancy—rather than having to provide an entire, singular redundant multichannel transceiver (e.g., 12 channel device) at a greater initial and replacement cost.

One important feature of the daughter-card connector assembly is the blind mate optical connector 107 on the first edge 105 of the opto-electric card 103. Such a connector facilitates the blind mating of the connector to the backplane. As shown, the optical connector is an MT style optical connector having alignment pins/alignment pin holes 150 on its ends and fiber end faces 151 presented in the center. In this particular embodiment, the distance between the alignment pinholes is relatively large compared to the relatively few fibers presented in the center of the ferrule. Such a configuration is generally preferred (although not necessary) because the longer distance between the fiber end faces and the alignment pinholes tends to improve the alignment fiber end faces with the fiber end faces of the mating con106nector on the backplane. Although an MT style connector is shown in the embodiment of FIGS. 1 and 2, other embodiments are possible within the scope of the invention. For example, essentially any blind mate optical connector can be used providing that it has a thin profile to accommodate the relatively small pitch between slots of the daughter-card connector assembly 100. For example, in one embodiment, the pitches less than 2 mm, and in another embodiment, less than 1.8 mm, and, in another embodiment, less than 1.5 mm.

As shown in FIGS. 1 and 2, one or more waveguides 111 connect the interposer 110a to the blind mate optical connector 107. In one embodiment, the waveguides are optical fibers 112 as shown in FIGS. 1 and 2. In yet another embodiment, the waveguides may be defined in the PCB such that the optical connector 107 optically couples with the PCB.

In one embodiment, the first edge of the card 104 also comprises an electrical interface 130 for connection to a mating connector on the backplane. In one embodiment, the electrical interface on the first edge is a blind mate electrical connector.

In one embodiment, the electrical interface on the 2^{nd} edge of the card is similar to that disclosed in U.S. Pat. No. 9,196,985, incorporated herein by reference. Likewise, in one embodiment, the second plane of the housing has a daughter card interface similar to the daughter card interface defined in the '985 patent. Specifically, in one embodiment, the daughter card interface comprises eye-of-the-needle connectors 120 along the second plane. (Such connectors are well known and will not be described herein in detail.)

In one embodiment, the optical component 110 comprises an interposer 110a and a chip 110b. The interposer 110a comprises an innovative interposer that minimizes hysteresis and simplifies optical alignments. One embodiment of the interposer of the present invention is disclosed, for example, in U.S. patent application Ser. No. 16/450,189, hereby incorporated by reference in its entirety. In one embodiment, the interposer 110a is perpendicular to the opto-electric card as shown in FIGS. 1 and 2. Such an embodiment has a number of advantages as described in the aforementioned application. In one embodiment, the interposer is disposed mid-board, thereby reducing the length of traces in the PCB or wire bonds between the electrical interface on the second edge and the interposer, thereby decreasing impedance/hysteresis. In one embodiment, the interposer is part of an onboard optical module mounted to the opto-electric card.

In one embodiment, the interposer integrates both the optical device and the chip. As used herein, the optical device may be any known or later-developed component that can be optically coupled to an optical conduit as described below. The optical device may be for example: (a) an opto-electric device (OED), which is an electrical device that sources, detects and/or controls light (e.g., lasers, such as vertical cavity surface emitting laser (VCSEL), double channel, planar buried heterostructure (DC-PBH), buried crescent (BC), distributed feedback (DFB), distributed Bragg reflector (DBR); light-emitting diodes (LEDs), such as surface emitting LED (SLED), edge emitting LED (ELED), super luminescent diode (SLD); photodiodes, such as P Intrinsic N (PIN) and avalanche photodiode (APD); photonics processor, such as, a CMOS photonic processor, for receiving optical signals, processing the signals and transmitting responsive signals, electro-optical memory, electro-optical random-access memory (EO-RAM) or electro-optical dynamic random-access memory (EO-DRAM), and electro-optical logic chips for managing optical memory (EO-logic chips)); or (b) a hybrid device which does not convert optical energy to another form but which changes state in response to a control signal (e.g., switches, modulators, attenuators, and tunable filters). It should also be understood that the optical device may be a single discrete device, or it may be assembled or integrated as an array of devices. It should also be understood that the optical device may be a single mode or multimode device. In one embodiment, the optical device is a surface emitting light source. In one embodiment, the surface emitting light source is a VCSEL. In one embodiment, the optical component is photo sensitive. In one embodiment, the photo sensitive optical component is a photodiode.

In one embodiment, the optical component works in conjunction with one or more electronic chips 110b. A chip as used herein refers to any electronic/semiconductor chip needed to facilitate the function of the optical component. For example, if the optical component is a transmitter, then the chip may be a driver, or, if the optical component is a receiver, then the chip may be a transimpedance amplifier (TIA). The required chip for a given optical component is well known in the art and will not be described here in detail.

Although the chip is disposed on the opto-electric card as shown in FIGS. 1 and 2, in other embodiments, it may be preferred to integrate the chip with optical device on the interposer as disclosed in the '189 Application.

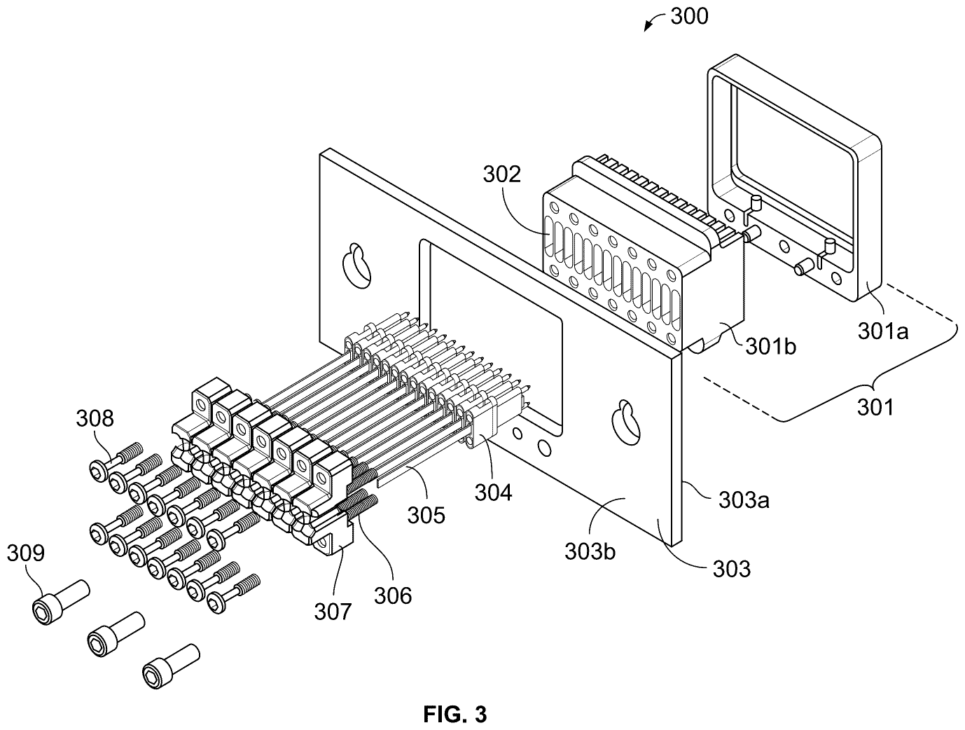

Now referring to FIG. 3, one embodiment of a backplane connector 300 of the present invention is shown. The backplane connector is configured to mate with a daughter-card connector assembly, for example the daughter-card connector assembly 100 shown in FIG. 1. The backplane connector has a front and rear orientation and comprises a retainer block 301 configured for attachment to a backplane 303. The retainer block 301 defines a plurality of ferrule slots 302, each slot configured to receive a ferrule 304. As shown, a plurality of ferrules 304 are configured to be disposed in the ferrule slots 302. A plurality of ferrule springs 306 are shown for urging the plurality of ferrules forward. The springs are retained in a plurality of ferrule spring retainers 307. The ferrule spring retainers are mounted rearward on the retainer block, wherein each ferrule spring retainer retains springs for two or more ferrules. Each of these features is described in greater detail below, along with selected alternative embodiments.

Retainer block 301 functions to secure the connector 300 to the backplane 303 and hold the ferrules in proper register with respect to the opto-electric cards of the daughter-card connector assembly. This can be achieved in different ways. For example, in the embodiment of FIG. 3, a portion of the retainer block “floats” relative to the backplane. For example, in this embodiment, the retainer block 301 comprises a floating block 301b, which defines the ferrule slots for receiving the ferrules and holding in proper register, and a bracket 301a for securing the floating block to the backplane. Specifically, the bracket is configured for fastening to the backplane with fasteners 309, such that the floating block is sandwiched between the bracket and the backplane, but not fastened to the backplane, thereby allowing the floating block to move relative to the backplane. In this particular embodiment, the bracket is fastened to the front 303a of the backplane, although the bracket may also be fastened to the rear 303b of the backplane. Additionally, although a floating retainer block is shown in this embodiment, it is possible, although perhaps not preferred, that the retainer block is rigidly secured to the backplane.

Although the retainer block shown in FIG. 3 has a single row array of ferrule slots, other configurations are possible within the scope of the invention. For example, in one embodiment, the retainer block may define multiple rows of ferrule slots.

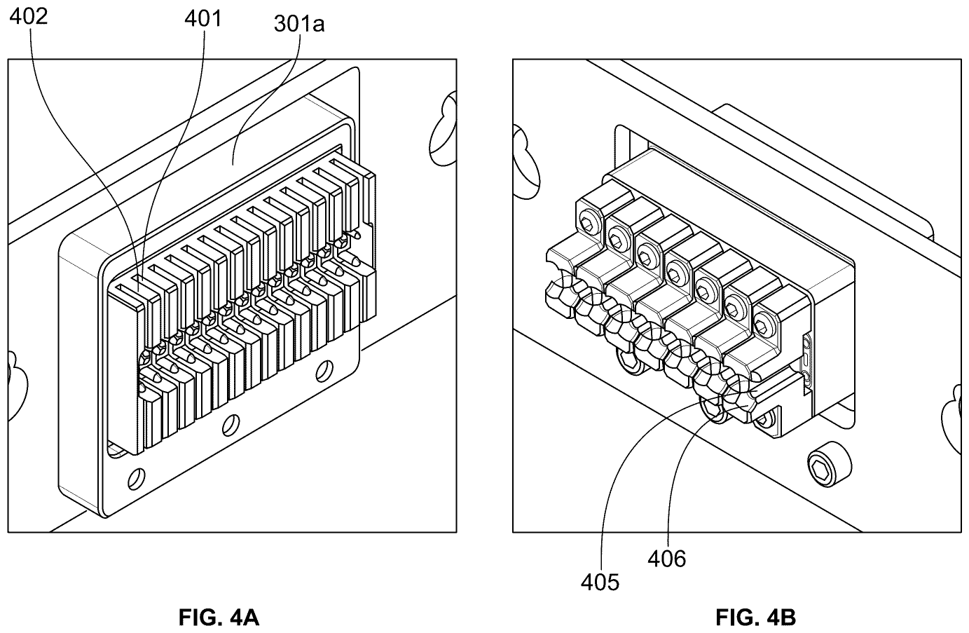

In one embodiment, the retainer block (or at least a portion thereof) comprises metal or other heat conducting material to draw heat away from the opto-electric cards of the daughter-card connector assembly. For example, in one embodiment, the opto-electric cards comprise one or more thermal conductive pads 130, as shown in FIG. 2b, to thermally couple with a thermally-conductive portion of the retainer to draw heat away from the opto-electric cards. For example, referring to FIG. 4a, in one embodiment, the retainer block comprises protruding thermally conductive ears 402 which defines slots 401 coincident with the ferrule slots such that slots 401 align with a leading-edge of an opto-electric card of the daughter-card connector assembly and thermally couple with the thermal conduction pads 130 when the daughter-card connector assembly 100 is coupled with the backplane connector 300. Those of skill in the art in light of this disclosure can determine other thermal conductive paths between the opto-electric boards and the backplane connector without undue experimentation.

The ferrule spring retainer functions to retain the springs that urge the ferrules forward. Applicant found that the relatively small pitch between the opto-electric cards makes the conventional approach of using a spring retainer for each ferrule difficult. Consequently, in one embodiment of the present invention, a single ferrule retainer retains springs for multiple ferrules. For example, referring to FIG. 3, each ferrule spring retainer retains the springs of two adjacent ferrules. In this particular embodiment, two springs correspond to each ferrule, and each ferrule spring retainer retains four springs. It should be understood that other embodiments are possible.

In the embodiment shown in FIG. 3, each ferrule spring retainer is fastened to the rear side of the retainer block with at least one fastener. In this particular embodiment, just two fasteners are used in an over/under relationship. Such a configuration allows for a close pitch between ferrule slots.

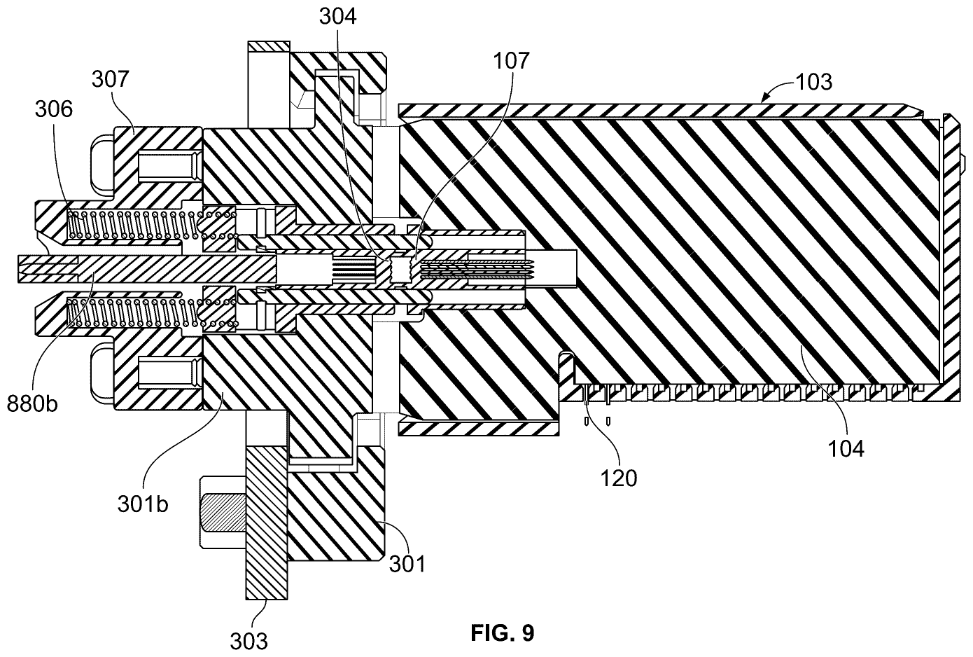

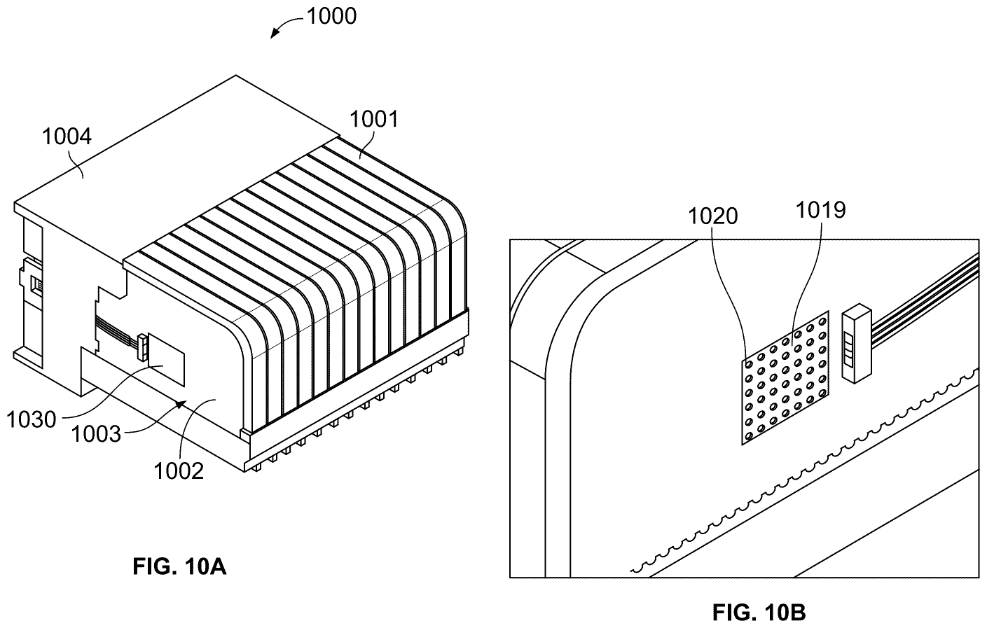

Referring to FIG. 4b, in one embodiment, each ferrule spring retainer defines at least one channel 405 through which optical cable 305 passes (see FIG. 3). In a more particular embodiment, each ferrule spring retainer defines two channels to accommodate the cables of two ferrules terminated with fiber(s). In one embodiment, the channel defines a beveled portion 406 at the point the optical cable exits the ferrule spring retainer. The beveled portion allows the cable to bend as it exits the ferrule spring retainer as shown in FIG. 8. As shown in FIG. 8, the cable is a ribbon cable, although variations are possible. For example, in one embodiment, the cable comprises a ribbon cable portion 880a (see FIG. 9) terminated to the ferrule, and a round cable portion 880b for easier cable management (bending) as described, for example, in US Patent Application Publication US20220283392A1. In another embodiment the fibers are in a cable which is terminated to the ferrule using traditional means.

As shown in FIG. 3, the backplane connector 300 comprises a plurality of ferrules for optical connection with the opto-electric boards of the daughter-card connector assembly. The function of a ferrule is well known and will not be described in detail herein. In this particular embodiment, the plurality of ferrules comprises expanded beam lensed ferrules. Expanded beam ferrules are generally preferred, although not necessary, because they do not require physical contact with the mating ferrule. Rather, as long as the distance along the optical axis remains essentially constant between the two mating ferrules. Sufficient optical coupling is achieved. In one embodiment, the plurality of ferrules comprises guide pins for alignment. In a more particular embodiment, the plurality of ferrules comprises MT-type ferrules.

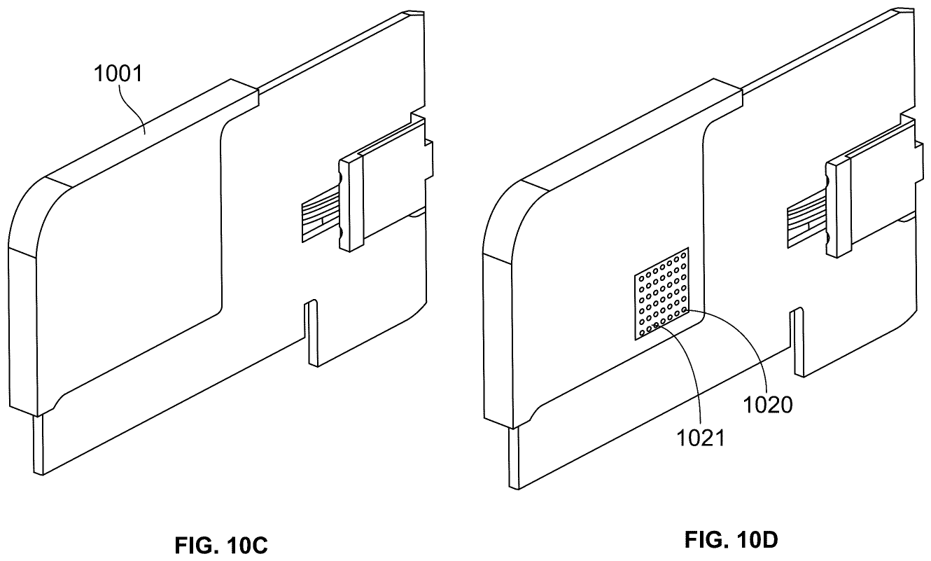

Referring to FIGS. 10a-10d, an alternative embodiment of the daughtercard connector assembly 1000 is shown having a heatsink 1001 to draw heat away from the wafers 1002 of the opto-electric cards 1003. Specifically, referring to FIG. 10a, the connector assembly 1000 is shown fully populated with opto-electric cards 1003. Each card comprises a heatsink 1001 to dissipate heat from the opto-electric driver 1030. Specifically, Referring to FIG. 10b, the opto-electric driver 1030 has been removed from one of the opto-electric cards to reveal a frontside ground pad 1019 with through-card vias 1020 to provide a thermal path from the frontside ground pad to the backside of the wafer and heatsink 1001. Referring to FIGS. 10c and 10d, the backside of an opto-electric card is shown. FIG. 10d shows a portion of the heatsink removed to reveal a backside thermal pad 1021 in thermal communication with vias 1020. The backside thermal pad 1021 is in thermal communication with the heatsink 1001. In one embodiment, the backside thermal pad 1021 is significantly larger than the front side ground pad 1019 to maximize the thermal coupling between the thermal pad and the heatsink 1001.

In one embodiment, the wafer is thermally coupled to backplane connector and/or the daughter card to communicate heat away from the wafer. For example, in one embodiment, the card edge connector of the PCB wafer comprises one or more thermal pads to conduct heat from the opto-electric card through the connector and into the backplane connector. In another embodiment, thermal connectors among the connectors 120 are configured to conduct heat from the opto-electric card to the daughter card. Alternatively, the heat sink 1001 may also be thermally coupled to the thermal pads or thermal conductors mentioned above. In one embodiment, the robustness of the heatsink 1001 may be used to dissipate heat from the daughter cards. In such an embodiment, the thermal conductors would be configured to conduct heat away from the daughter cards and into the heatsink 1001 for dissipation into the environment. Still other embodiments for dissipating heat will be obvious to one of skill in the art in light of this disclosure.

These and other advantages may be realized in accordance with the specific embodiments described as well as other variations. It is to be understood that the above description is intended to be illustrative, and not restrictive. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled.

What is claimed is:

1. A backplane connector for mating with a daughter-card connector assembly, said backplane connector having a front and rear orientation and comprising:
a retainer block configured for attachment to a backplane and defining a plurality of ferrule slots, each slot configured to receive a ferrule;
a plurality of ferrules disposed in said ferrule slots;
a plurality of ferrule springs to urge said plurality of ferrules forwardly; and
a plurality of ferrule spring retainers for retaining said ferrule springs and being mounted rearward on said retainer block, wherein each ferrule spring retainer retains springs for two or more ferrules.

2. The backplane connector of claim 1, wherein said ferrule slots are arranged as a linear array, and wherein said each ferrule spring retainer retains springs of two adjacent ferrules.

3. The backplane connector of claim 1, wherein two of said a plurality of ferrule springs correspond to each ferrule, and wherein said each ferrule spring retainer retains four springs.

4. The backplane connector of claim 1, wherein said each ferrule spring retainer is fastened to said retainer block with no more than two fasteners.

5. The backplane connector of claim 1, wherein said each ferrule spring retainer defines at least one channel through which optical cable passes.

6. The backplane connector of claim 5, wherein said channel defines a beveled portion at the point said optical cable exits said ferrule spring retainer, said beveled portion allowing said cable to bend as it exits said ferrule spring retainer.

7. The backplane connector of claim 5, wherein said cable is a ribbon cable.

8. The backplane connector of claim 5, wherein said cable comprises a ribbon cable portion and a round cable portion for easier cable management.

9. The backplane connector of claim 1, wherein said ferrule retainer block is metal to absorb heat from said daughter-card connector assembly.

10. The backplane connector of claim 1, wherein said retainer block comprises a bracket and a floating block defining said ferrule slots.

11. The backplane connector of claim 10, wherein said bracket is configured for fastening to said backplane such that said floating block is sandwiched between said bracket and said backplane but not fastened to the backplane, thereby allowing said floating block to move relative to said backplane.

12. The backplane connector of claim 11, wherein said bracket is fastened to the front of said backplane.

13. The backplane connector of claim 10, wherein each of said ferrule slots is configured to align with a leading-edge of an opto-electric card of said daughter-card connector assembly.

14. The backplane connector of claim 1, wherein said plurality of ferrules comprise expanded beam ferrules.

15. The backplane connector of claim 1, wherein said plurality of ferrules comprise guide pins for alignment.

16. The backplane connector of claim 15, wherein said plurality of ferrules comprise MT type ferrules.
